(19) United States
(12) Patent Application Publication
(10) Pub. No.: US 2024/0329653 A1
(43) Pub. Date: Oct. 3, 2024

(54) SYSTEMS AND METHODS FOR ROBOTIC CONTROL USING LIDAR ASSISTED DEAD RECKONING

(71) Applicant: Brain Corporation, San Diego, CA (US)

(72) Inventor: Micah Richert, San Diego, CA (US)

(21) Appl. No.: 18/622,287

(22) Filed: Mar. 29, 2024

Related U.S. Application Data
(60) Provisional application No. 63/456,062, filed on Mar. 31, 2023.

(51) Int. Cl. G05D 1/246; G05D 1/245; G05D 111/50

(52) U.S. Cl. CPC G05D 1/246; G05D 1/245; G05D 2111/54

(57) ABSTRACT

Systems and methods for robotic control using LiDAR assisted dead reckoning are disclosed herein. According to at least one non-limiting exemplary embodiment, a robot may accurately localize itself over time by detecting parallelized environmental surfaces, such as walls or shelves arranged in a parallel manner, extracting a primary orientation of those surfaces using LiDAR data, and utilizing the primary orientation to accurately define its heading angle in real time, thereby enabling localization via dead reckoning.

### PRIORITY

This application claims the benefit of U.S. provisional Patent Application Ser. No. 63/456,062, filed Mar. 31, 2024, the entire disclosure of which is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for robotic control using LiDAR assisted dead reckoning.

### SUMMARY

The foregoing needs are satisfied by the present disclosure, which provides for, inter alia, systems and methods for robotic control using LiDAR assisted dead reckoning.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

According to at least one non-limiting exemplary embodiment, a method, device and non-transitory computer readable medium are disclosed for moving a robot in an environment. Wherein the method comprises, producing a computer readable map of the environment using data from one or more sensors coupled to the robot, the computer readable map comprises a first orientation; determining a second orientation of a plurality of objects within the environment based on the computer readable map based on a histogram; calculate a heading angle of the robot based on detecting at least one surface of an object and the second orientation of the objects on the computer readable map; and determine displacement based on a measured velocity, measured time, and calculated heading angle of the robot. The method further comprising populating the histogram by calculating, for every scan used to produce the computer readable map, an angle between two points; providing the calculated angle to the histogram; and determining the second orientation based on the largest peak of the histogram which is above a threshold value. And, wherein, the histogram is wrapped every 90 degrees for each quadrant of the computer readable map.

According to at least one non-limiting exemplary embodiment, the method further comprises, causing the robot to change its heading angle while navigating a route; determining the heading angle has exceeded 90 degrees or fallen below zero degrees with respect to the histogram; and determining the robot has moved into an adjacent quadrant in the counter clockwise direction if the heading angle grew to exceed 90 degrees, or determining the robot has moved into another adjacent quadrant in the clockwise direction if the heading angle fell below 0 degrees. Wherein, the two points selected per angle calculation are separated by four degrees or more.

According to at least one non-limiting exemplary embodiment, the two points selected per angle calculation are separated by four degrees or more.

According to at least one non-limiting exemplary embodiment, the method further comprises calculating a second value for the heading angle of the robot using a gyroscope, determining a difference between the second value and the heading angle of the robot calculated via the histogram, and adjusting the second value based on the difference. The adjusting of the second value removes accumulated error, or drift, associated with the gyroscope.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2A (i-ii) depict a ranging sensor configured to generate point clouds of an environment representing the locations of objects in accordance with some embodiments of this disclosure.

FIG. 3A is a graph comprising two measurements of a robot heading angle using a gyroscope and dead reckoning, according to an exemplary embodiment.

FIG. 3B is a computer readable map produced by a robot in a parallelized environment, according to an exemplary embodiment.

FIG. 4 depicts a primary orientation of a computer readable map, according to an exemplary embodiment.

FIG. 5A-B depict construction of a histogram used to calculate the primary orientation of an environment, according to an exemplary embodiment.

FIG. 6A depict a robot calculating a primary orientation of an environment for a given noisy scan, according to an exemplary embodiment.

FIG. 6B depicts various line segments formed via detected points on an object surface, the lines being used to determine the primary orientation of the environment, according to an exemplary embodiment.

FIG. 6C comprises a histogram of values for potential primary orientations of the environment, according to an exemplary embodiment.

FIG. 6D depicts a range threshold employed to ensure line segments used to calculate a primary environmental orientation are on a single surface, according to an exemplary embodiment.

FIG. 7 depicts a robot detecting surfaces aligned with the primary orientation of the environment to calculate its heading angle and thereafter navigating using dead reckoning, according to an exemplary embodiment.

FIG. 8 is a process flow diagram illustrating a method for performing a control cycle using the dead reckoning methodology of the present disclosure, according to an exemplary embodiment.

FIG. 9 is a process flow diagram illustrating a method for constructing a histogram used to determine the primary orientation of the environment, according to an exemplary embodiment.

FIG. 10A depicts a robot navigating a turn which is greater than ninety degrees, according to an exemplary embodiment.

FIG. 10B depicts a measurement of a robot heading angle as the robot navigates a turn greater than ninety degrees while employing the dead reckoning methods disclosed herein, according to an exemplary embodiment.

All Figures disclosed herein are © Copyright 2024 Brain Corporation. All rights reserved.

### DETAILED DESCRIPTION

Currently, robots may utilize many sensors, systems, and processes to move, track their displacement, and track locations of nearby objects. A common approach in the art is to utilize specialized instruments, namely gyroscopes, to calculate angular displacement and position of a given robot. Gyroscopes, however, are noisy instruments configured to measure angular velocity which are susceptible to drift, wherein integrating a gyroscope to determine angular position would in turn integrate the accumulated drift error. Some methods exist in the art for correcting and/or accounting for gyroscopic drift. The most readily apparent method would involve commanding the robot to navigate in a straight line or stop completely, measure drift/bias, and subtract the bias, however this would impede autonomous operation and impose extra constraints on navigation. Other methods may involve using other sensors, such as ranging sensors, and the position of the robot with respect to detected objects, however these methods are often computationally taxing and may not be a viable option for all robots.

An alternative solution known within the art is a method called dead reckoning which involves navigating and localizing a robot using only velocity, time, and heading angle. Multiplying the velocity by the time traveled along the distance of the heading angle yields highly precise location estimations while being computationally light-weight. Velocity may be measured using wheel encoders which are substantially less susceptible to drift than a gyroscope, as with clocks that measure time. As discussed above, however, calculating the heading angle using components susceptible to drift, like gyroscopes, introduces inaccuracy. Further, methods for calculating heading angle using complex scan matching algorithms, such as those using range sensors, may not be viable or optimal solutions. Since gyroscopic drift becomes significant over long routes/long periods of time, these concerns may not be applied to robots that operate in small, confined spaces. For robots operating in large commercial spaces navigating hour long routes, however, gyroscopic drift and computational recourses become a more substantial consideration. When navigating long routes through large spaces, small errors in heading angles when mapping an early portion of the map could cause later mapped portions to accumulate substantial errors. Accordingly, there is a need in the art for the systems and methods which aim to enable dead reckoning by providing a lightweight, rapid, and reliable method for determining heading angle for a robot without reliance on drift-susceptible instruments.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for robotic control using LiDAR assisted dead reckoning. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAY® vehicles, etc.), trailer movers, vehicles, and the like. Robots may also include any autonomous and/or semi-autonomous machine for transporting items, people, animals, cargo, freight, objects, luggage, and/or anything desirable from one location to another.

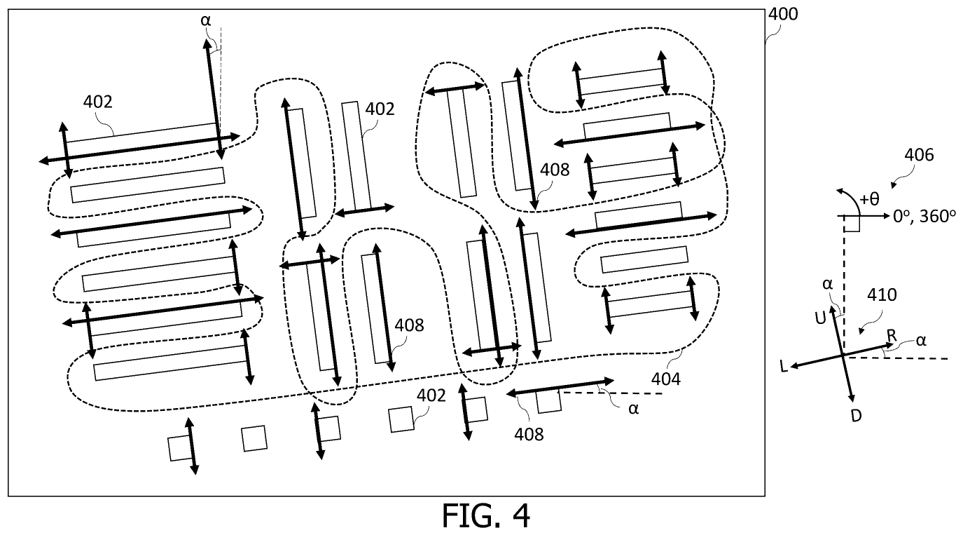

As used herein, a primary orientation of an environment refers to the vertical and/or horizontal orientation of various object surfaces within an environment which align in parallel or perpendicular to each other. For example, a supermarket with a plurality of parallel aisles may include a primary orientation which is in the direction of the aisles, or perpendicular to them. Many environments, such as the exemplary supermarket, may include a four-quadrant primary orientation, wherein the surfaces of the objects therein span in parallel to or perpendicular to with respect to other object surfaces. Some environments may be arranged in a three-quadrant primary orientation with object surfaces either running parallel to other object surfaces or at a ±120° angle with respect to the other surfaces. Similarly, some environments may be arranged with eight-quadrant primary orientation, wherein the object surfaces span in parallel to each other or differ at 45° increments. An exemplary environment comprising of a primary orientation that is discretized into four quadrants is shown and discussed in FIG. 4 below.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) reduce computational load required by a robot to localize itself, navigate, and map its environment; (ii) reduce reliance on drift-prone instruments; and (iii) improve localization accuracy of robotic devices and thereby improve accuracy of computer readable maps produced therefrom. Other advantages are readily discernable by one having ordinary skill in the art given the contents of the present disclosure.

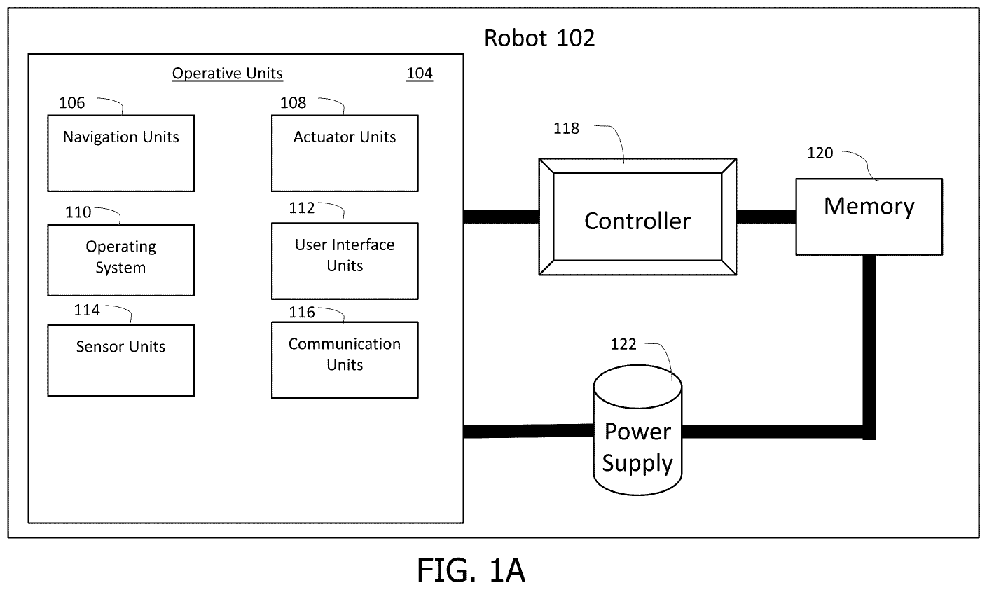

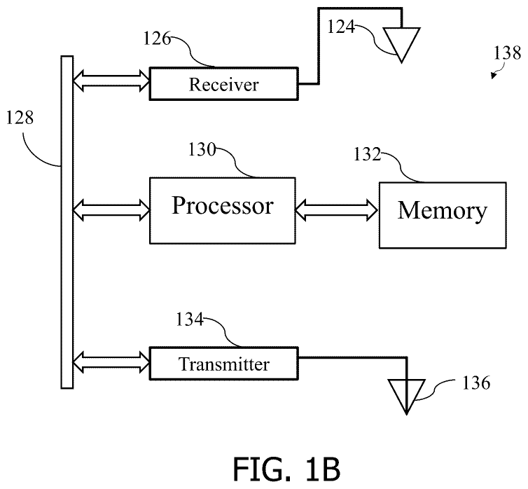

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors) and other peripherals. As previously mentioned and used herein, processor, microprocessor, and/or digital processor may include any type of digital processing device such as, without limitation, digital signal processors (“DSPs”), reduced instruction set computers (“RISC”), complex instruction set computers (“CISC”), microprocessors, gate arrays (e.g., field programmable gate arrays (“FPGAs”)), programmable logic device (“PLDs”), reconfigurable computer fabrics (“RCFs”), array processing devices, secure microprocessors and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be internal to or on board robot 102 and/or may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processors described. In other embodiments different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find its position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; or repose cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases, actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processor, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

One of ordinary skill in the art would appreciate that the architecture illustrated in FIG. 1B may also illustrate an external server architecture configurable to effectuate the control of a robotic apparatus from a remote location. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high level tasks (e.g., planning a route to avoid obstacles) and processing devices 138 for performing low-level tasks (e.g., producing actuator signals in accordance with the route).

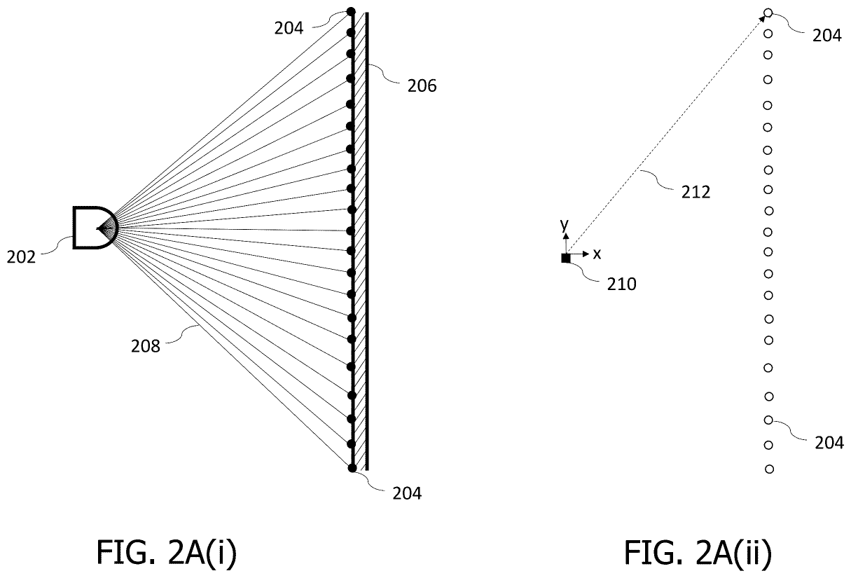

FIG. 2A (i-ii) illustrates a planar light detection and ranging (“LiDAR”) sensor 202 coupled to a robot 102, which collects distance measurements to a wall 206 along a measurement plane in accordance with some exemplary embodiments of the present disclosure. Planar LiDAR sensor 202, illustrated in FIG. 2A (i), may be configured to collect distance measurements to the wall 206 by projecting a plurality of beams 208 of photons at discrete angles along a measurement plane and determining the distance to the wall 206 based on a time of flight (“ToF”) of the photons leaving the LiDAR sensor 202, reflecting off the wall 206, and returning back to the LiDAR sensor 202. The measurement plane of the planar LiDAR 202 comprises a plane along which the beams 208 are emitted which, for this exemplary embodiment illustrated, is the plane of the page.

Individual beams 208 of photons may localize respective points 204 of the wall 206 in a point cloud, the point cloud comprising a plurality of points 204 localized in 2D or 3D space as illustrated in FIG. 2 (ii). The points 204 may be defined about a local origin 210 of the sensor 202. Distance 212 to a point 204 may comprise half the time of flight of a photon of a respective beam 208 used to measure the point 204 multiplied by the speed of light, wherein coordinate values (x, y) of each respective point 204 depends both on distance 212 and an angle at which the respective beam 208 was emitted from the sensor 202. The local origin 210 may comprise a predefined point of the sensor 202 to which all distance measurements are referenced (e.g., location of a detector within the sensor 202, focal point of a lens of sensor 202, etc.). For example, a 5-meter distance measurement to an object corresponds to 5 meters from the local origin 210 to the object.

According to at least one non-limiting exemplary embodiment, sensor 202 may be illustrative of a depth camera or other ToF sensor configurable to measure distance, wherein the sensor 202 being a planar LiDAR sensor is not intended to be limiting. Depth cameras may operate similar to planar LiDAR sensors (i.e., measure distance based on a ToF of beams 208); however, depth cameras may emit beams 208 using a single pulse or flash of electromagnetic energy, rather than sweeping a laser beam across a field of view. Depth cameras may additionally comprise a two-dimensional field of view rather than a one-dimensional, planar field of view.

According to at least one non-limiting exemplary embodiment, sensor 202 may be illustrative of a structured light LiDAR sensor configurable to sense distance and shape of an object by projecting a structured pattern onto the object and observing deformations of the pattern. For example, the size of the projected pattern may represent distance to the object and distortions in the pattern may provide information of the shape of the surface of the object. Structured light sensors may emit beams 208 along a plane as illustrated or in a predetermined pattern (e.g., a circle or series of separated parallel lines).

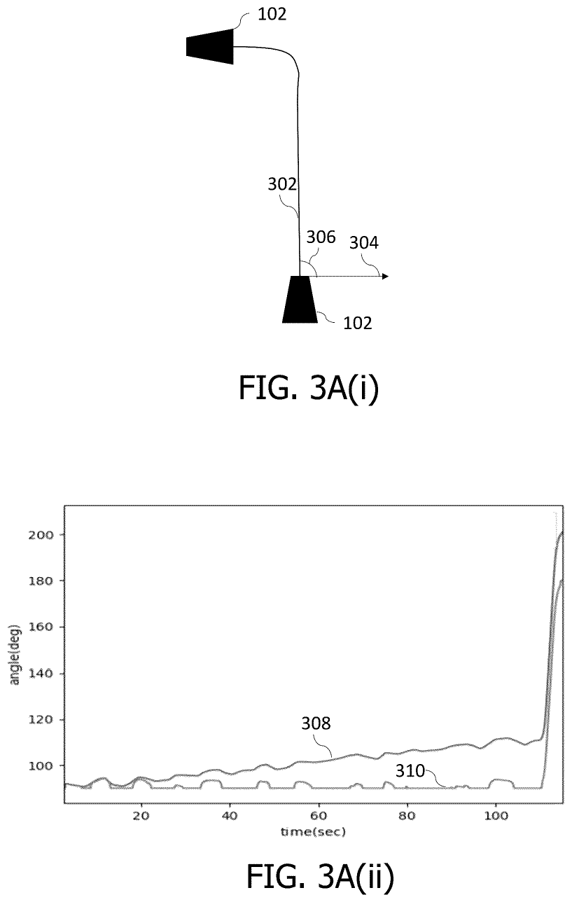

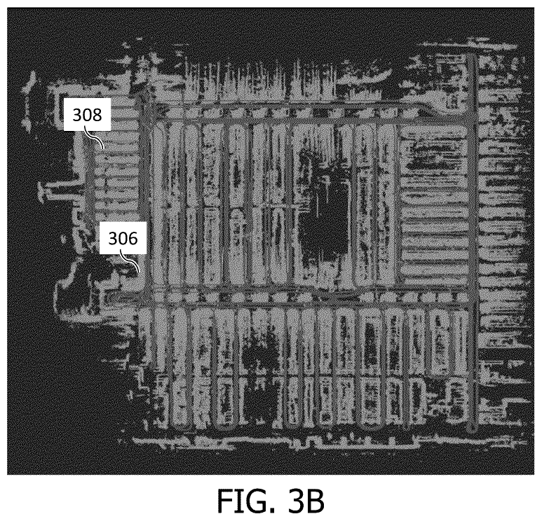

FIG. 3A (i) depicts a robot 102 navigating a route 302, according to an exemplary embodiment. The route 302 includes a straight portion followed by a sharp left-hand turn. As will be used herein, the plane of the page will serve as an initial reference for angles discussed unless otherwise specified, wherein an angle of zero or 360° is shown by ray 304 pointing directly rightwards along the page. Angles herein will follow the right-hand rule convention with the z-axis pointing outwards from the page (towards the viewer), wherein a positive angle is in the counterclockwise direction as shown by angle 306 which comprises a positive value. As illustrated, route 302 travels at an angle of +90° until the left-hand turn, at which it is travelling at an angle of +180°, both angles relative to the reference vector 304.

FIG. 3A (ii) depicts a graph comprising angle estimates of a robot 102 tracked using a gyroscope 308 and the dead reckoning methods of the present disclosure 310 as the robot 102 navigates the route 302, according to an exemplary embodiment. The path was navigated in a lab under ideal circumstances, free from objects, bumps, or other obstacles, wherein precise control of the robot 102 could be ensured to enable measurement of heading angle using the two estimation methods 308, 310.

To generate the curves shown, the robot 102 was commanded to travel a straight-line path and not consider the gyroscope as a means for localization, wherein other localization methods were utilized instead. Namely, odometry based on wheel encoders, distance to measured features, such as notable markers (e.g., quick response codes), landmarks, and/or beacons, etc., which may or may not be present in real-world environments and is more computationally taxing than using a gyroscope. In other words, the gyroscope simply serves as a measurement tool to determine the heading angle of the robot 102 and does not provide an input to control the direction of travel of the robot 102. Curve 308 represents the readings from the gyroscope as the robot 102 travels this straight-line path 302.

As discussed above, gyroscopes are configured primarily to calculate angular velocity. Gyroscopes are popular devices within the art of robotics for calculating orientation due to their small size and cheap cost. Gyroscopes often rely on spinning or moving components being measured to a high degree of precision, wherein small imperfections, temperature fluctuations, perturbations (e.g., bumps as the robot travels), integration over long time periods, and the like will cause the gyroscope to drift. Drift refers to the accumulation of error over time. To calculate the angle of travel for the robot, the gyroscopic data over a time period is integrated. In turn, the accumulated error is also integrated leading to the curve 308 slowly drifting upward despite the robot 102 traveling a straight line. It can be appreciated that trace 308 shows the angle at which the robot 102 perceives it is heading based on the gyroscope data, which if corrected for, may cause the robot 102 to slowly turn as a correction method. This correction, however, is not correcting the true path of the robot 102, rather it is adjusting its path based on an erroneous measure from the gyroscope.

Trace 310 utilizes the dead reckoning systems and methods of the present disclosure to track the angle of the robot 102 traveling in a straight line. As will be discussed in further detail, the methods used do not rely on instruments which are subject to drift, namely the gyroscope. Accordingly, the estimated heading angle is much more stable (i.e., flat), wherein the small bumps are caused by an unwrapping case discussed in more detail below and minor bumps in the floor. Unlike the gyroscope curve 308 which gradually increases due to drift accumulation, the curve 310 remains flat until the robot 102 performs the turn at approximately 110 seconds.

Dead reckoning, as used herein, refers to a process of navigating and localizing a robot using only its heading angle and directionless speed across a period of time. Measuring the directionless speed of the robot 102 is a trivial process and can be measured using wheel encoders, actuator signals, and the like. As shown in FIG. 3A (ii), calculating the heading angle of the robot using a gyroscope may include error due to drift, making it an unreliable method of tracking the heading angle. Accordingly, the following discussion and figures will extract a heading angle for a robot 102 for use in dead reckoning navigation in a manner that is free from drift.

Tracking heading angle over time is essential for localizing a robot 102, wherein improper localization can also affect mapping, performance, and various other aspects of autonomy. When localizing nearby objects using range sensors, the distances to those objects from the location of the sensors 114/robot 102 need to be translated into locations in the environment, wherein improperly localizing the robot 102 would in turn cause improper localization of the objects. As another example, in the far right of the graph, the robot at approximately 110 seconds executes a left turn of about 90 degrees. Using the gyroscope, the robot 102 estimates it has over-turned when it has not, which would then cause later localizations of the robot 102 and objects to carry with it this over-turned error. Thus, there is a need for better estimation of heading angle for a robot 102 which is less or not at all reliant on drift-susceptible components while still remaining cost effective.

While on a small-scale route, gyroscopic drift can be negligible, however the same cannot be said for larger routes, such as those which take an hour or more to execute. The graph shown in FIG. 3 spans about two minutes, however robots 102 which operate in large commercial spaces often navigate for 30 minutes or hours at a time. Without markers or known features placed in the environment, which may not always be possible or cost effective, localizing the robot 102 can be a difficult task. Gyroscopic drift may be partially accounted for by occasionally stopping the robot 102 and measuring the value of the gyroscope on flat ground while idle, however this would need to be done periodically and at different heading angles, which would impede autonomous performance.

FIG. 3B illustrates an exemplary map of a supermarket captured by a robot 102 operating therein, according to an exemplary embodiment. The illustrated map comprises an occupancy map, wherein pixels are marked as either occupied if an object is detected at the location (grey), unoccupied if there are no objects detected at those locations (black). The map further comprises a route 312 navigated by the robot 102 in light grey pixels. The route 312 involves the robot 102 traversing in and out of aisles formed by objects 314. As shown on the map 310, the objects 314 are all approximately rectangular and oriented either parallel or perpendicular to other rectangular objects 314, and can be approximately oriented along some primary axis. For the illustrated example, the primary axis is aligned with the up/down and left/right on the page. More specifically, some of the rectangular objects 314 include edges or sides which span up and down and others span left and right, wherein there are marginally few surfaces of objects in diagonal orientations and/or with non-flat (i.e., curved) surfaces. Selection of a reference vector signifying zero degrees for the primary axis is somewhat arbitrary, depending on the map. Most supermarkets, warehouses, and other large retail and commercial environments are configured in a similar, parallelized manner for space efficiency. In some environments, building supports, such as support columns and walls, are also arranged in a similar linear/rectangular manner. This common feature of large, commercial environments, wherein robots 102 are often tasked with navigating large distances therein, will be leveraged to improve the localization abilities of the robot 102.

FIG. 4 depicts an exemplary computer readable map 400 produced by a robot 102 as the robot 102 navigates a route 404, according to an exemplary embodiment. The goal is to determine a primary orientation 410 of the objects on the computer readable map 400 defined with respect to the initial orientation of the map 400. As discussed above, the primary orientation refers to the orientation of the surfaces of the objects within the environment being aligned parallel or perpendicular to each other. The initial orientation of the map 400 is arbitrary and defined by orientation 406 which, for simplicity, includes the left-ward direction along the page being zero or 360° with +θ following the right-hand rule convention. For instance, the robot 102 on initial start-up may construct the map while presuming it is facing right-ward on the map as the initial orientation, wherein this initial start-up orientation may or may not align with the primary orientation of the map 400 such as in the illustrated example. The angle θ, as used herein, is defined with respect to the plane of the page as shown by legend 406, wherein θ=0 corresponds to right-ward along the page. In some exemplary instances, the initial orientation may be decided based on the initial forward direction of the robot 102 when it is powered on or begins route 404. That is to say, the initial angle of the map 400 is not needed to be known and the map 400 could be rotated any amount with respect to the page or interface on which the map is displayed. The map 400 may have been produced during a prior execution of one or more routes through the environment by a given robot 102 and/or other robots 102.

The map 400 contains a plurality of objects 402 thereon. These objects 402 are approximately parallel or perpendicular to each other. The objects 402 may include surfaces localized via points from a LiDAR sensor, sonar sensor, or other exteroceptive sensor configured to generate points or determine occupancy of a given pixel/location on the map 400. These surfaces may represent aisles, shelves, storage racks, or other approximately rectangular objects commonly found in retail environments, warehouses, and/or other commercial spaces. Each of these surfaces can include an orientation 408 shown with double-headed arrows on some of the surfaces. The illustrated objects 402, due to their rectangular shape, each contain surfaces which span across the primary orientation shown by arrows 408. The surfaces of these objects 402 are (approximately) either perpendicular or parallel to other object 402 surfaces, although these arrows 408 are not illustrated for each object 402 surface.

It is to be appreciated that the exemplary map shown in FIG. 4 is an idealized, noise-free map produced using perfect localization and mapping wherein all objects 402 are perfectly oriented either parallel or orthogonal to each other for the sake of simplicity and clarity. Later figures and discussion will consider sensory noise and imperfections in the orientation of the objects 402.

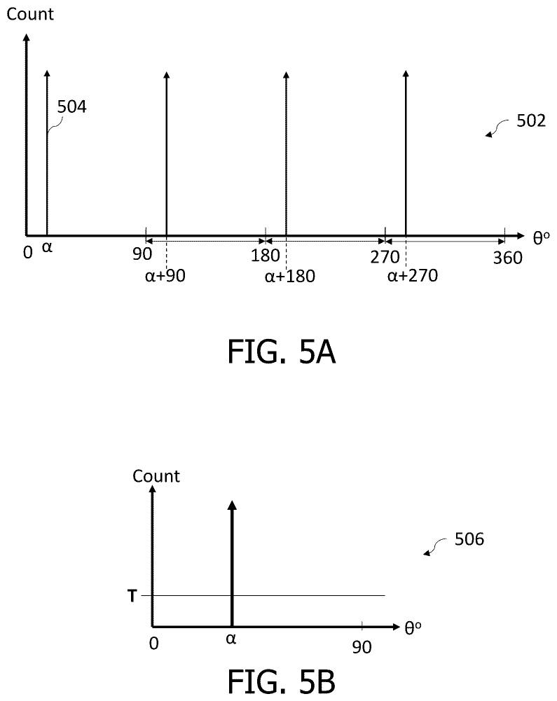

Systems and methods for calculating the angle α of the directions 408 to determine a primary orientation 410 will be described next in FIGS. 5A and 5B. The angle α, as used herein, corresponds to the angular difference between the primary orientation of the environment and the plane of the page in the figures discussed. The plane of the page may correspond to an arbitrary initial orientation of the map (e.g., 400) as stored in the robot 102 memory 120.

The orientations for each surface, that is the angle θ of the arrows 408 with respect to orientation 406, are added to a histogram shown in FIG. 5A according to an exemplary embodiment. If the primary orientation of the surfaces 408 are already aligned with the initial orientation 406 of the map 400, θ would have values of 0, 90, 180 or 270°, but that may not be the case in every scenario. The histogram would yield four spikes beginning at θ=α and repeating every 90°, wherein α refers to the angular difference between the initial map orientation 406 and primary orientation 410. In this example, α is the angular difference between the right-ward direction, “R”, on primary orientation 410 and 0°/360° of the initial orientation 406. Since the primary orientation is discretized into four quadrants, each arrow 408 shown in FIG. 4 generates two spikes on the histogram 502: α and α+180. Since the objects 402 are all rectangular, the four surfaces of each object 402 produce values on the histogram 502 at α, α+90, α+180, and α+270 degrees. Accordingly, the histogram 502 includes four values for α which correspond to, with reference to FIG. 4, the up/down arrows 408 and the left/right arrows 408.

The primary orientation 410 is then calculated based on the most prominent value of α exhibited by the direction 408 of the surfaces. The notation used herein to define primary orientation 410 is up, down, left, and right (“UDLR”) which is appreciated to be different from the orientation 406 of the page. Angles defined with respect to the primary orientation 410 are defined about the right-ward direction “R” as zero degrees in a counter-clockwise manner.

FIG. 5A depicts a histogram 502 of θ values for the orientations 408 of the objects 402 from the map 400 relative to the initial orientation 406 shown in FIG. 4, according to an exemplary embodiment. The vertical axis represents counts, or a number of arrows 408 on map 400 which are oriented along the values of θ denoted by the horizontal axis of the histogram 502. Spikes 504, represented by delta functions due to the idealized nature of the environment, are found at α, α+90°, α+180°, and α+270° values of θ. Since the environment above is idealized (i.e., noise free and comprising purely rectangular objects), all the spikes 408 are either oriented along α, α+90°, or inverse, and are hence represented by the delta functions with infinitesimally small width. The histogram 502 can be ‘wrapped’ every 90°, wherein the value of θ resets to zero at every 90° interval, and the counts are concatenated. As shown in FIG. 5B, which depicts the histogram 506 constrained to and wrapped on an interval of [0, 90°), the spikes 504 all align to the same value of α. Accordingly, the primary orientation 410 is determined to be aligned along α, or integer multiples of 90° from α.

Since the scenario in FIG. 4 is idealized, the wrapped and concatenated histogram 506 contains only a single delta function at angle α. In real-world scenarios wherein noise is present and not all object 402 surfaces are perfectly parallelized, the values of the histograms 502, 506 may be more spread out as a (probabilistic) distribution. However, in most environments with, e.g., shelves, rectangular displays, walls, or other permanent rectangular objects, it should still be expected that there exist a peak approximate to the primary orientation α, wherein wrapping the four intervals would further amplify the value of α with respect to the noise. In other words, wrapping of the histogram 502 from [0, 360) to [0, 90) amplifies the signal to noise ratio of the angle α of the primary orientation 410. According to at least one non-limiting exemplary embodiment, threshold T may comprise a non-zero integer count, wherein values for θ below the threshold are not considered for values of α to ensure that if a primary orientation 410 is calculated, the primary orientation is determined with sufficient certainty and using enough data points.

According to at least one non-limiting exemplary embodiment, the threshold T may represent a dynamic signal to noise ratio (“SNR”) threshold, requiring any peak α to be resolved with sufficient clarity from the other measurements/bins in the histogram 506. Such a threshold may be implemented as a method for determining if the environment has a primary orientation or not for use of the dead reckoning navigation methodology disclosed herein. Environments which do not comprise a value for α above the threshold T likely do not include a sufficient number of objects oriented in a perpendicular manner, unlike the environment in FIG. 4 where the majority of the object 402 surfaces are either parallel or perpendicular to the surfaces of other objects 402.

According to at least one non-limiting exemplary embodiment, threshold T may represent a dynamic threshold based on Rⁿ (e.g., R²) circular statistics. For instance, the histogram 506 may be expanded to encompass the full 360° circle. A weighted summation of the sine and cosine components for each angular bin of the expanded histogram may be multiplied by the counts for the respective bin. This yields an (x, y) vector with a length indicative of noise in the histogram 506, pointing along angle α. Such length may be compared to a static or dynamic threshold to determine if a viable primary orientation exists in the environment.

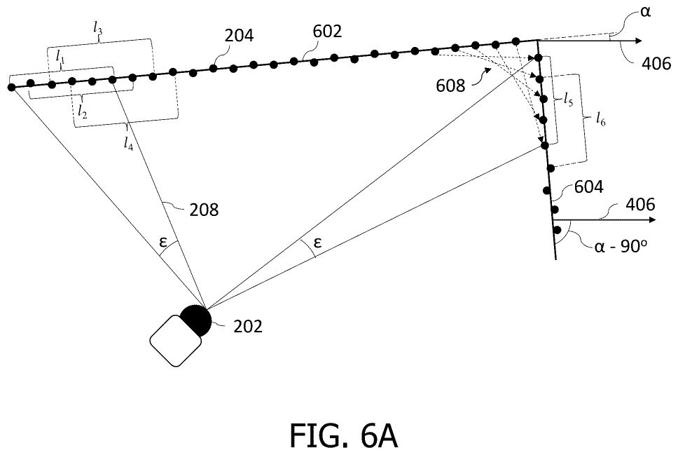

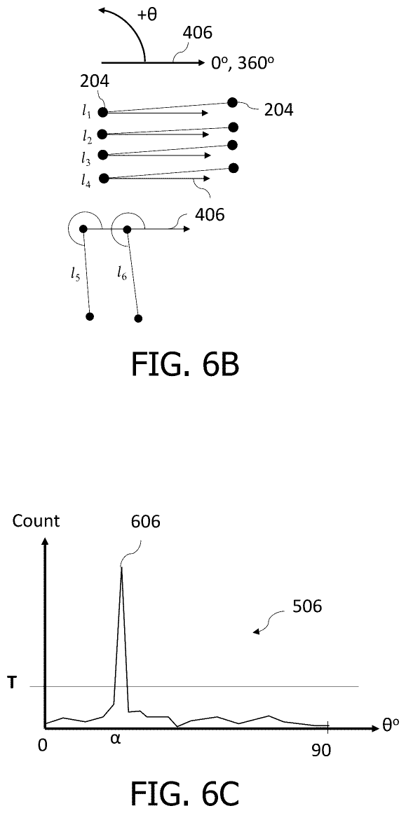

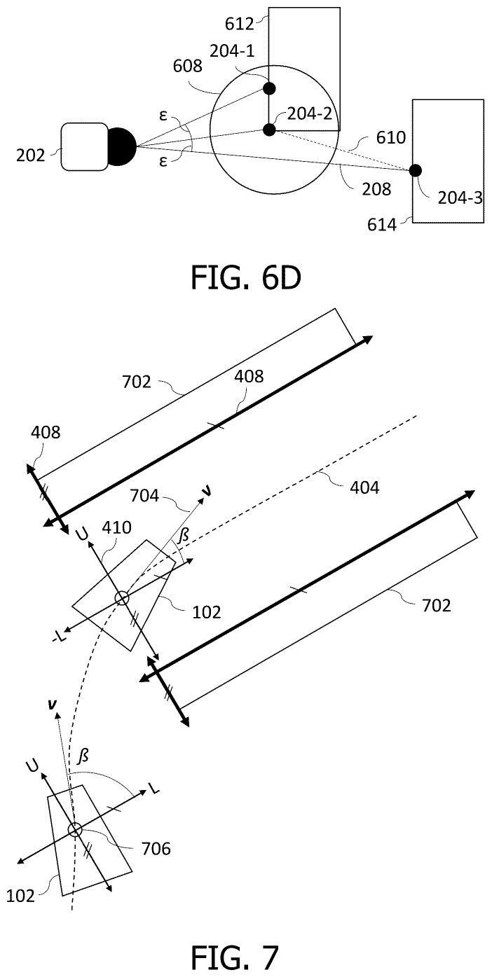

Systems and methods for calculating the direction 408 of a surface from a noisy LiDAR scan will be discussed next in FIG. 6A-C.

In a more realistic scenario including noise and imperfect localization, FIG. 6A depicts a sensor 202 detecting a flat surface 602 in order to extract a primary orientation α of the surface 602, according to an exemplary embodiment. The sensor 202 is positioned in an arbitrary location at an arbitrary orientation. The surfaces 602 may be presumed to comprise a flat surface in the physical world. The surface 602 is localized via a plurality of points 204 measured by the sensor 202 which include noise. That is, not all of the points 204 form a straight line across the surface 602. Thus, it is appreciated that the above depiction in FIG. 4 of the surface orientations 408 is simplified and idealized, wherein precise methods for determining the surface orientations 408 will be discussed here. Further, the robot 102 only contains measurements for this single surface 602 and can be assumed to not have sensed any other surfaces within the environment, wherein only the illustrated points 204 are considered in the following discussion.

To detect the surface orientation of the surface 602, pairs of points 204 are selected. Preferably, the points 204 should not be adjacent because directly adjacent points are too close and susceptible to noise affecting their location relative to each other. In the illustrated embodiment, the pairs of points 204 are selected every 5 points (or 5 beams 208 of separation), however other values are considered such as 4, 6, or 8 points or ε degrees apart depending on the sensor 202 angular resolution. The angular separation between points 204 of a pair should not be too large to improve the likelihood that both points 204 of the pair lie on a single surface. In some embodiments, a threshold range can be implemented between the two points 204 to rule out pairs of points which are too far apart and could likely be detecting different surfaces, such as the edge of a wall in the foreground and another wall in the background further away as illustrated in FIG. 6D below. Each pair defines a line segment lₙ between point n and point n+ε, with ε being the separation constant equal to 5 in this example. These line segments are defined for l₁ through l_{N-ε} for a scan with N total points 204.

According to at least one non-limiting exemplary embodiment, the formation of the line segments may be further employed to detect corners, curved surfaces, and/or other landmarks. The controller 118 may determine that the angle of the line segments formed proximate to the corner between surfaces 602 and 604 decreases (in this instance, when increasing n is moving left to right in the scan), which would indicate a change of orientation between surfaces 602 and 604. The change rate of the angles of the line segments may further be different for sharp corners as shown versus curved surfaces or other surfaces. Accordingly, the controller 118 may utilize these functions of angle with respect to n to detect corners, unique shapes, and other landmarks which may aid in delocalization subroutines discussed herein used to localize the robot 102 if it loses its place in the environment/on its map. In some embodiments, mapping of corners may be useful in path planning for robots 102, e.g., configured to navigate next to corners of walls, such as for cleaning robots 102.

In FIG. 6B, line segments l₁ through l₄ are shown separately adjacent to the initial orientation 406 of the computer readable map which, for the sake of explanation, is the plane of the page. One skilled in the art would appreciate that assigning the initial orientation to the plane of the page is an arbitrary assignment for illustrative purposes only, wherein the initial orientation 406 could be, for example, the forward direction the robot 102 began navigation. Each of these line segments can define a value of θ between the primary orientation 406 and their orientation on the map. Each of these values of θ are then counted in the wrapped histogram 506 to form a peak 606, as shown in FIG. 6C. Due to the imperfection of the LiDAR measurement of distances to points 204, the peak 606 centered at α is broadened compared to the idealized histogram 506 shown in FIG. 5B. This causes the peak 606 to be approximately centered about the angle α corresponding to the primary orientation of the surface 602 with respect to the initial orientation 406. Although only line segments l₁ through l₄ are shown for surface 602, it is appreciated that additional line segments and angle calculations as described are also performed on other pairs of points which lie proximate to the surface 602.

The environment shown in FIG. 6A also contains another, perpendicular surface 604. The two surfaces 602, 604 may represent, for example, a corner of a square room. On that surface 604, line segments between pairs of points are also sampled. In the illustration, only the two line segments l₅ and l₆ are shown for clarity, however it is appreciated that additional pairs of points 204 are processed in a similar manner. The angle formed between these line segments and the initial orientation 406 has been reproduced separately for clarity as well in FIG. 6B. As mentioned above, θ follows the right-hand rule convention and accordingly, the angle between the initial orientation 406 and l₅ or l₆ is approximately (due to noise) 270°+α. Since the histogram 506 is truncated and wrapped around an interval of [0, 90), these two segments contribute to the peak 606 centered about θ=α.

Some pairs of points 204 proximate to the corner formed by the two surfaces 602, 604 would yield widely varying angles, shown by dashed arrows 608. These segments, defined by two points 204 each separated by 5 points 204 in-between or an angular difference of ε, also contribute to the histogram 506. However, due to the limited number of these point pairs as compared to point pairs which lie entirely along surfaces 602, 604 the angle counts from these segments 608 are quickly diminished as they would yield counts substantially lower than the peak 606 and threshold T.

It is appreciated that other surfaces could be present in the environment. If those additional surfaces are oriented perpendicular to the illustrated surface 602, the histogram 506 would look substantially similar due to the wrapping form θ∈[0, 90) degrees, regardless of those additional surfaces going parallel to or perpendicular to either of surfaces 602 or 604. The additional surfaces may further enhance the height of the peak 606 with respect to the average counts for other values of θ.

Some environments may, however, contain circular objects, curved walls, or other surfaces which are not aligned with the primary orientation or have no particular orientation at all (e.g., a circular table). In these such environments, there may not exist a value for θ which is above the threshold T. In such environments with no discernible primary orientation, the dead reckoning methodology used herein may not be sufficient or viable. In environments that are oriented in a substantially rectangular manner (e.g., FIG. 4) but may also contain a few circular objects, curved walls, etc. the θ values for line segments defined along those surfaces may still populate the histogram 506. However, given enough scans of a sufficient number of other objects which are aligned with the primary orientation, these outliers would eventually be drowned out by the peak 606. Further, the dead reckoning localization methodology used herein may still remain viable so long as the robot 102 can detect at least one of the surfaces that are aligned with the primary orientation even if it is detecting other surfaces that are not, such as the circular table. As discussed above, many inside environments are bounded by a roughly rectangular perimeter, so a robot may navigate a route 404 adjacent to the perimeter to determine peak 606 in a histogram 506. Weighting of consecutive line segments having similar α values indicative of a long continuous straight-line surface may also be used to increase their impact on populating peak 606 in a histogram 506 of the environment.

The threshold T defines the minimum required count for a value of θ to determine that value to correspond to the primary orientation of the environment α. In some non-limiting exemplary embodiments, the threshold T may comprise a fixed count threshold, comprising a fixed numerical value. In some non-limiting exemplary embodiments, the threshold T may be a dynamic function based on the number of scans or total number of counts in the histogram 606. In some non-limiting exemplary embodiments, the threshold T may represent a requisite signal to noise ratio (“SNR”) needed for a peak 606 to be determined as the primary orientation α which would have a value proportional to the average value of the histogram counts across [0, 90) degrees. In some embodiments, the width of the peak 606 may also be required to be below a threshold width such that a singular primary orientation can be extracted or estimated therefrom.

Although the process for populating the histogram 506 is shown in FIG. 6A for a single scan, it is appreciated that this process can be repeated for any number of scans including scans during multiple runs of a given route 404 or scans from different routes through the same environment. The points 204 shown in FIG. 6A could, in some exemplary scenarios, be derived from multiple scans taken over time from one or multiple sensor units 114. Preferably, more scans of the surfaces 602, 604, and other surfaces would yield a more accurate estimation of the value of α by increasing the value of the peak 606. A stronger peak 606 may also aid in removing outliers from consideration, such as corner segments 608 or segments across curved or irregular surfaces. A scan in this context could comprise any number of points 204 generated by a sensor 202.

As discussed, real-world data from LiDAR sensors 202 may be noisy and not yield flat, smooth surfaces 602 or 604 as depicted in FIG. 6A-B with straight lines, instead producing noisy surfaces as shown by points 204. Although no single pair of points 204 may perfectly align with the primary orientation α, given a sufficient number of point 204 pairs the primary orientation angle α may be accurately resolved.

FIG. 6D depicts a distance threshold 608 used to filter line segments lₙ used to calculate the primary orientation of the environment α, according to an exemplary embodiment. The scenario depicted comprises a LiDAR sensor 202 collecting a scan of an environment containing two objects 612, 614. The entirety of the objects 612, 614 are shown for clarity, however it is appreciated that from the perspective of the sensor 202 and/or robot 102 (i.e., on its maps) it may not be able to discern these as distinct objects. Since the goal is to extract the primary orientations of the surfaces of the objects 612, it is beneficial to filter line segments which span across two different object surfaces from consideration in calculating the primary orientation α. Accordingly, a distance-based threshold 608 may be implemented.

As shown above in FIG. 6A, the pairs of points 204 selected to form line segments lₙ used in the calculation of α are separated by an angle shown by ε. The angle ε may represent the angular distance between 2, 3, 4, 8, etc. two beams 208 emitted from the sensor 202 which form line segments lₙ. Shown are three points 204-1, 204-2, 204-3, with pairs 204-1, 204-2 and 204-2, 204-3 forming two line segments there between. The line segment formed between points 204-1 and 204-2 fall within the threshold range 608. The pair 204-2 and 204-3, however, do not fall within the threshold range 608 due to both points 204-2, 204-3 landing on different object surfaces. Accordingly, the line segment 610 formed by points 204-2 and 204-3 can be filtered from consideration when constructing the histogram 506 and calculating α.

FIG. 7 depicts a robot 102 maneuvering through an environment along path 404 using the dead reckoning method of the present disclosure, according to an exemplary embodiment. As discussed above, a primary challenge in accurate localization is determining the true heading angle β(t) of the robot 102 at any time t while accounting for or negating any drift in the instruments used to measure the heading angle β(t) over time. In the illustrated scenario, the controller 118 of the robot 102 has determined the primary orientation 410 of the computer readable map. In some exemplary embodiments, the controller 118 may determine the primary environment using only the present measurements of the object 702 surfaces to extract the primary orientation. In some exemplary embodiments, the robot 102 may have previously navigated the environment and determined the primary orientation. Arrows 408 which are oriented along the primary orientation 410 are shown on some of the surfaces of the nearby objects 702, wherein the annotated surfaces with arrows 408 correspond to the detectable surfaces by the sensor units 114 of the robot 102. As the robot 102 travels a route 404, it continuously senses and localizes these surfaces via one or more sensor(s) 202 in real time to get an accurate and up-to-date calculation on the value of α, denoting the primary orientation of these objects 702. The illustrated velocity vectors v 704 are tangent to the route 404 at all locations shown (except where the route 404 is perfectly straight, wherein v is in line with route 404). The magnitude |v| would be determined based on the speed of the robot 102 using data from wheel encoders and in accordance with any safety limits on speed. If the heading angle β(t) can be accurately determined, the robot 102 can effectively localize itself using only its directionless speed |v|, time traveled, and heading angle β(t). This method of movement and tracking using only (|v|, β(t)) over a tracked time period is referred to as “dead reckoning”. The heading angle β(t) is defined about a point 706 which defines the location of the robot 102 in the environment, wherein the point 706 is surrounded by a footprint of the robot 102 when digitally representing the position and area occupied by the robot 102 on a map. Although point 706 is shown in the geometric center of the robot 102, other positions for the point 706 (e.g., in the front-center of the robot 102) are considered without limitation. By identifying the primary orientation α of the surfaces of objects 702 and based on the position and orientation of those surfaces with respect to the sensor which detects those surfaces, the heading angle of the robot 102 can be accurately calculated in real time. It is appreciated that a fixed transform applied to range measurements taken at an angle from a sensor origin 210 translates the range measurements to positions with respect to point 706. Vectors U and L are fixed in orientation (but not location) aligned with the primary orientation α as the robot follows path 404 and heading angle β(t) is defined as the angle between vectors L and v. In a first position, at lower left in this illustration, β(t) is large and decreases as robot follows path 404 into an aisle between objects 702 and surfaces 408. It is appreciated that determining the pose of the sensor which detects the surfaces is equivalent to determining the pose of the point 706 as the sensors are assumed to be at fixed and/or known positions with respect to point 706.

Velocity can be measured accurately and without drift via wheel encoders (or step counting for step motors) and/or motor feedback, which track (electro) mechanical components in the wheels or chassis of the robot 102 moving past a sensor. For instance, some encoders use notches/grooves or magnets in a wheel which pass by a sensor configured to detect the grooves, or vice versa (e.g., sensor could be placed in the rotating component as opposed to the stationary chassis). Since these devices produce counts, which in turn translate to rotations of a wheel, velocity can be determined without risk of a component being susceptible to drift (other than wheels changing size due to wear, which is negligible for most robotic applications) Similarly, clocks used to measure time are highly precise and, although still susceptible to drift, are orders of magnitude more precise than integrating a gyroscope.

When differential drive robots 102 are navigating in a straight line, the encoders for each wheel will normally agree on a straight-ahead velocity and experience minimal slippage. Slip or slippage occurs when a wheel, tread, or other means of locomotion either (i) rotate without translating (e.g., rotating on ice), or (ii) translate without rotating (e.g., dragging across a surface). When executing a turn, an angular component of the velocity is introduced, and slippage may increase as a sheer force is introduced from the angular component of velocity. Slippage may be more of a concern for lightweight and/or fast-moving robots. Slippage also occurs often during turns, making heading angles difficult to calculate via wheel encoder data alone. In some embodiments, wheel encoder information may be adjusted to account for slippage based on predetermined algorithms. In an ideal differential drive robot free from slippage, the difference between encoders of wheels on the inside and the outside of a turn can be used to determine the robot orientation, however wheel encoders may not be configured to detect when either type of slippage occurs. Accordingly, a robot 102 using the LiDAR measurements to detect surfaces of objects 702 which do not slip, extracting primary orientations as shown by arrows 408 of those surfaces, and continuously localizing itself with respect to those surfaces to determine the current heading angle of the robot 102, the controller 118 may accurately calculate the heading angle of the robot 102 without reliance on wheel encoders to determine turn angles, thereby removing possible error caused by slippage and enabling use of dead reckoning.

In robots 102 with steerable wheels, such as tricycle-wheel or four wheeled robots 102, these steerable wheels are often coupled to a steering shaft or other mechanical components comprising gears. Backlash (i.e., mechanical slop or play) in these gear assemblies often results in erroneous or inaccurate steering angle measurements. Further, since wheels of robots 102 are not infinitesimally thin, the point of contact between the wheel and ground may further alter the true heading angle of the robot 102 as it navigates turns, wherein encoders cannot measure this point of contact. That is to say, use of steering shaft encoders and/or feedback is insufficient in calculating the heading angle to a requisite accuracy over long distances. Advantageously, by referencing LiDAR measurements of object 702 surfaces, the controller 118 may calculate the heading angle of the robot 102 via relative distance using instruments typically far more precise than the steering shaft column encoders and less prone to mechanical inaccuracies.

According to at least one non-limiting exemplary embodiment, use of LiDAR scans to extract a primary orientation of the environment, then using those scans to identify the current heading angle of the robot 102 may be used to detect the occurrence of wheel slippage. If the estimated heading angle β(t) from the LiDAR-based method disagree substantially from the estimated heading angle from wheel encoder data alone, it can be determined that wheel slippage has occurred and the robot 102 is, at least partially, delocalized. Stated another way, if the robot 102 determines its heading angle β(t) calculated via the LiDAR-based method and using internal sensors, such as encoders/gyroscopes, disagree then slippage may have occurred. Identifying that the robot 102 is, at least in part, delocalized my initiate additional re-localization subroutines. For instance, the controller 118 may search for familiar landmarks observed before the slippage occurred, and determine its current location based on its distance to those familiar landmarks, and adjust its estimated location in the environment accordingly.

Returning to FIG. 7, consider the plane of the page to be the initial orientation of the map used by the robot 102. As the robot 102 travels, it detects surfaces of objects 702, generates the histogram 506, and calculates the primary orientation β of the map as shown by arrows 408. Since the sensor(s) of the robot 102 can continuously detect the surfaces of objects 702, the primary orientation of the map can be continuously calculated. Based on the localization data of the nearby surfaces, the robot 102 is provided with a heading angle β(t) defined with respect to the primary orientation α of the surfaces of objects 702 being detected. Provided that the objects 702 remain sensed by the robot 102 such that α and β(t) can be continuously calculated, tracking of the heading angle β(t) thereafter becomes trivial and dead reckoning is enabled. In order to follow a route 404, the controller 118 may determine control signals which cause the robot 102 to navigate with a velocity vector 704 which is tangent to the route 404 at point 706, wherein imprecision in the control signal commands which may cause the robot 102 to deviate from the route 404 are fed back into the system when, using the LiDAR sensors, the heading angle is again calculated using the adjacent surfaces.

In some embodiments, routes 404 are stored as discrete sets of poses for the robot 102 to achieve in series, wherein the control signals issued by the controller configure the robot 102 to change its current (x, y, β(t), |v|) position, defined at a first pose along the route, into the next (x, y, β(t), |v|) position along the route given a set time duration to achieve the translation/rotation. Stated another way, the directional velocity vector 704 v may be defined for each pose or node along the route 404, wherein the controller 118 may use the systems and methods of the present disclosure to ensure the heading angle of the robot 102 matches the prescribed state of the route nodes and calculate control signals which effectuate such translation.

According to at least one non-limiting exemplary embodiment, the heading angle β(t) determined by scanning of surfaces as described herein can be compared to the track of the robot determined from wheel encoder and steering angle data as an internal check, using methods not affected by gyroscope drift. For instance, a kinematic model of the robot 102 based on its drive/track configuration (e.g., unicycle, differential drive, tricycle, etc.) may be implemented to predict the position of the robot 102 given a set of actuator commands and/or encoder readings. This prediction could be compared to the prediction generated by the dead reckoning method used herein. The difference between these estimates, namely in the final angular orientation of the robot, may be the result of slippage. It is appreciated that if substantial slippage has occurred, the translational component of the dead reckoning methodology disclosed herein will also carry a similar error, however since heading angle is determined invariant of wheel encoders the heading angle calculation should still be free from slip-induced errors. If these results indicate a substantial (i.e., greater than a threshold) amount of slippage, the robot 102 could be commanded to stop or enter a re-localization subroutine as described above.

One may appreciate that distance scanning of objects, such as by LiDAR, is already done continuously for collision avoidance and navigation and wheel encoder information is also available from actuators for moving the robot through the environment, so the robot 102 is likely already gathering the information needed for dead reckoning navigation. Further, dead reckoning may be useful for facilitating a robot to return to a desired route after collision avoidance by calculating the heading angle β with respect to any nearby object(s) surface.

Advantageously, dead reckoning using only these parameters may be substantially quicker to process than more complex simultaneous localization and mapping (“SLAM”) algorithms. One common method in the art for accounting for gyroscopic drift is to compare translation measured by the gyroscope to values from other sensors, namely range sensors such as LiDAR. Such methods, however, require the controller 118 to perform many complex scan-matching algorithms (e.g., iterative closest point, pyramid scan match, etc.), to determine translation in between scans. The dead reckoning methods of the present disclosure aim to not only reduce reliance on components susceptible to drift, but also reduce computational load on the controller 118 to maneuver the robot 102. If the primary orientation of the environment α can be calculated using nearby objects within a single scan, calculating the heading angle of the robot 102 is reduced to a series of arctangent operations which are substantially quicker than scan matching multiple scans. Additionally, while the assumption that the environment is aligned along a primary orientation 410 holds, the real-time feedback of the heading angle of the robot 102 measured with respect to continuously sensed objects enables rapid estimation error calculation and correction, including accounting for gyroscope drift and route correction.

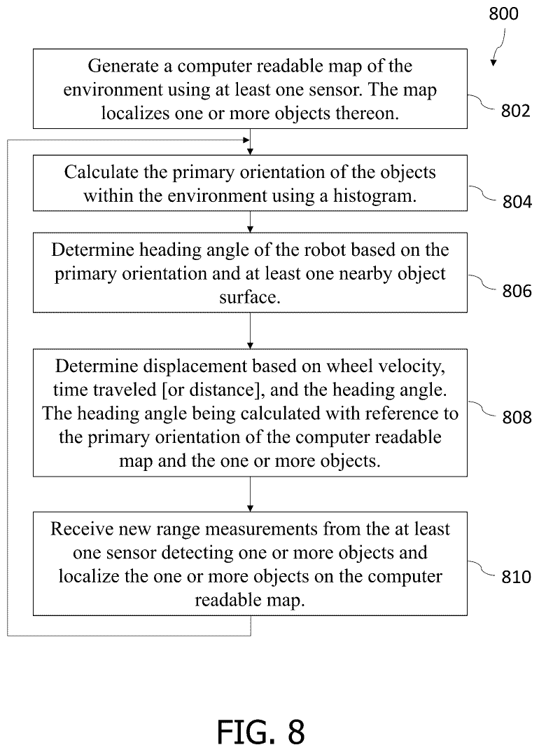

FIG. 8 is a process flow diagram illustrating a method 800 for a controller 118 of a robot 102 to navigate the robot 102 using dead reckoning, according to an exemplary embodiment. Steps of the method 800 are effectuated via the controller 118 executing instructions from a non-transitory computer readable storage medium.

Block 802 begins with the controller 118 producing a computer readable map of the environment. The computer readable map is produced using data from various sensor units 114 which localize objects and track the location of the robot 102 over time. Block 802 may include the controller 118 being provided with an existing computer readable map of the environment, such as one produced at an earlier time, while doing a different task, or from a different robot 102. In some instances, the controller 118 is producing the computer readable map as it navigates the environment for the first time, autonomously or while in manual control by a user, while executing method 800. For method 800 to continue, at least one object should be detected at least in part.

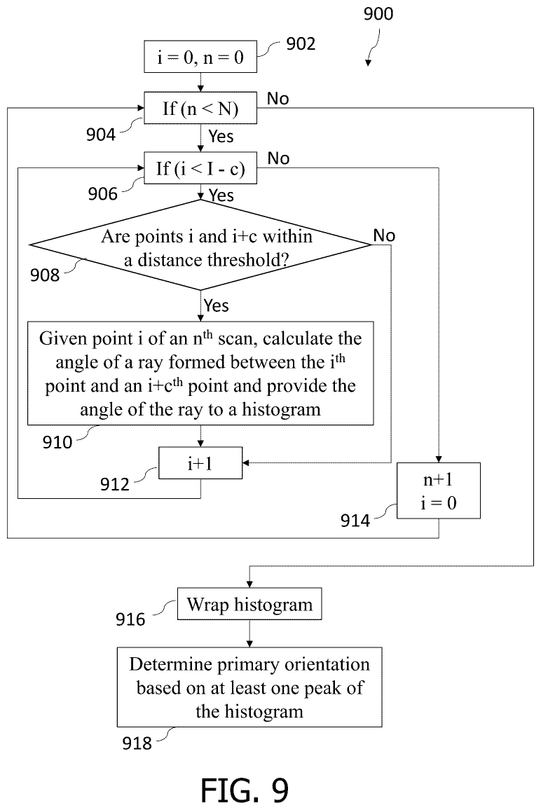

Block 804 includes the controller 118 calculating the primary orientation 410 of the objects within the environment using a histogram based on the computer readable map. A more precise description of how the histogram is produced is described next in FIG. 9. In short, localized points on the map, such as pixels occupied by objects or points 204 measured by a range sensor 202, define various surfaces of objects on the map. Line segments can be drawn between near-adjacent pairs of these points as shown in FIG. 6 for example, wherein the most common occurrence for the angle of these line segments is determined to be the primary orientation 410, as shown in FIG. 5A-B for example. The controller 118 may, in some embodiments, only consider pairs of points that are within a threshold range of each other to ensure both points are detecting the same surface of an object.

Block 806 includes the controller 118 determining a heading angle of the robot based on the primary orientation 410 and at least one nearby object surface. The nearby object surface provides a static reference from which the primary orientation of the environment α, and therefore the current heading angle of the robot β(t), can be continuously determined and updated. The nearby object surface may provide an orientation of the robot 102 with respect to its environment in order to account for any localization drift accumulated before the primary orientation is determined, such as in cases where the robot 102 begins in a location where there are no or very few (e.g., below threshold T counts) adjacent objects or walls to sense.

It is appreciated that step 804 may require the robot 102 to scan multiple object surfaces, or a sufficiently large portion of a single object surface (e.g., a wall), such that the controller 118 has access to enough points to extract the primary orientation α of the environment from accurately. In some embodiments, the dead reckoning methodology described herein may require a threshold number of scans or points of the surrounding environment to be gathered before being utilized as the method of navigation and localization.

Block 808 includes the controller 118 determining displacement of the robot 102 based on wheel velocity or translation (e.g., as measured by wheel encoders), time traveled, and heading angle. The heading angle may be calculated with reference to the primary orientation 410 of the computer readable map which is determined based on the detection of nearby objects. Since the heading angle is readily and reliably calculated in blocks 802-806, the controller 118 may maneuver and track the robot 102 over time using dead reckoning. The robot 102 determines its displacement from its location on the map in blocks 802-806 based on dead reckoning calculation, wherein the controller calculates displacement based on the velocity, heading angle, and time executed. For example, the robot 102 may travel at 2 meters per second for 0.25 seconds for a given control cycle, thereby translating 0.5 meters in the direction of the calculated heading angle.

Given the presumption that the detected objects are static ones, which can be filtered from dynamic moving objects using other methods known in the art, and are oriented in a substantially parallelized/orthogonal manner, the heading angle of the robot 102 can be accurately tracked using one or more of these parallelized surfaces. To ensure the surfaces used accurately reflect the primary orientation 410 of the environment, the histogram in block 804 ensures that accurate selection of the primary orientation 410 is achieved. The wrapping advantageously drowns out noisy measurements, such as from sensory noise, corners, or a few circular objects, to yield a prominent spike around the primary orientation 410. Under the assumption that the environment is parallelized, viewing only one of the objects therein would provide a strong signal to the controller 118 indicating the primary orientation 410 of the object and therefore the environment. Such presumption can be later verified as the robot 102 collects more data about its environment, wherein the spike should remain at approximately the same value for α. For instance, the threshold T shown in FIG. 5B may be configured to verify the assumption holds, wherein an environment without a primary orientation would not yield a spike above the threshold T.

It is appreciated that once the primary orientation α of the environment as a whole is extracted, the robot 102 may still calculate its heading angle from objects which do not align with the primary orientation. The controller 118 may detect that a given object does not align with the primary orientation and utilize other objects on the map to determine the amount of misalignment the given object has with respect to the primary orientation α, and subsequently calculate the present heading angle of the robot 102 with respect to this surface and its known offset from the primary orientation α.

Block 810 includes the controller 118 receiving new range measurements from the at least one sensor, wherein the new range measurements detect one or more objects. The objects could be the same and/or new objects as detected in block 802. These new range measurements may each indicate a vector extending a length equal to the measured range along a certain angle with respect to the sensor origin 210. Presuming these sensor origins 210 remain static on the robot 102 and their locations are known, the controller 118 may then translate a range measurement of d meters into a location on the map relative to the robot 102. The position of the robot 102 can be calculated using the dead reckoning method in block 808. Method 800 returns back to block 804 to recalculate the histogram using either only the new data collected or by adding additional counts to the existing histogram. The loop formed by blocks 804-810 may represent a single localization and mapping control cycle, wherein the controller 118 localizes the robot 102 and nearby objects.

FIG. 9 is a process flow diagram illustrating a method 900 for a controller 118 of a robot 102 to calculate the primary orientation 410 of a computer readable map by constructing a histogram 506, according to an exemplary embodiment. Steps of method 900 are effectuated via the controller 118 executing computer readable instructions from a non-transitory storage medium 120. Method 900 may be executed for every scan collected by one or more sensors, every control cycle, or periodically (e.g., every 5 seconds, after moving 3 meters, etc.)

Block 902 begins by initializing variables. For the illustrated example, i represents a given point 204 of an n^{th} scan, wherein each scan contains a total of I points 204 and the map is produced using N total scans. N, I, n, and i all represent integer numbers. In some alternative non-limiting embodiments, N may represent a set number of scans less than all of the scans required to produce the computer readable map (e.g., all scans within the past 30 seconds). For instance, some controllers 118 of some robots 102 may have limited processing recourses and can therefore not reliably and quickly store and process a large number of scans. The N scans must detect at least one surface of an object.

Blocks 904 and 906 form a nested for loop. The loop performs the steps in blocks 908, 910, 912, and 914 for I−ε points per scan n for N total scans used to generate the computer readable map. As shown above in FIG. 6, pairs of points 204 used in the analysis are not directly adjacent and are spaced ε points apart, wherein ε is a constant value. Preferably ε should be greater than 1 as to be less susceptible to noise while being small enough to ensure the majority of point 204 pairs lie on the same surface of an object.

Block 908 includes the controller 118 determining if the points i 204 and the point i+ε 204 are within a distance threshold. The distance threshold is implemented to handle two scenarios: (i) the point i lies on a different surface than point i+ε (e.g., point i may be on the edge of a foreground object, and point i+ε may be on a background object), and (ii) noisy measurements at close range.

Regarding the first case, the goal of the histogram is to resolve the primary orientation of the objects within the environment using their surfaces which are assumed to be mostly parallel or orthogonal to each other. Producing counts for the histogram 506 using points 204 which lie on different object surfaces would be counter to this goal and introduce added noise to the histogram 506. Accordingly, points i and i+ε 204 must be at or below a certain distance apart from each other. If the points i and i+ε 204 are too far apart, it is likely that they lie on two different objects, and are thus excluded from the histogram 506 counts as shown by the controller 118 jumping to block 912 to increment i.

Regarding the second case, range sensors such as LiDARs have certain angular and spatial resolutions which are generally static as a function of measured range. For instance, a LiDAR sensor may include a 1 degree angular resolution and a +/−2 cm spatial resolution, which remain static regardless of the sensor measuring 50 cm distances or 5000 cm distances, assuming both are within the range of the sensor. When sensing objects which are close to the LiDAR the generated points 204 become more spatially dense on the surface of that object as opposed to objects further away which generate less dense points 204. It is appreciated that each point 204 is still separated by the set angular resolution (e.g., 1 degree in the above example). These highly dense points 204, however, are more susceptible to the spatial uncertainty as compared to longer range measurements. For instance, with reference to FIG. 6, a plurality of segments 406 are depicted. Had the object 602 been closer to the sensor 202, the horizontal length (with respect to the plane of the page) of the segments would be shorter, but the difference in height (also with respect to the plane of the page) would be the same. The closer object 602 would thereby be more susceptible to providing erroneous counts as a result of uncertainty in the range and therefore should be excluded. Accordingly, the distance threshold also requires that the points i and i+ε be separated by greater than a minimum spatial distance. The precise value of this threshold would be based on the spatial and angular resolution of the particular LiDAR sensor used.

According to at least one non-limiting exemplary embodiment, if the spatial distance between points i and i+ε 204 are less than the minimum distance threshold, the controller 118 may instead increment the value of s until the spatial separation between these two points 204 exceeds the minimum threshold, the incremented value which satisfies this minimum threshold being represented by ε′ herein. It is appreciated that the points i and i+ε′ 204 should still be under the maximum distance threshold discussed above.

If the two points i and i+ε 204 (or i+ε′ in alternative embodiments) are spaced a distance greater than the minimum distance threshold and below the maximum distance threshold, the controller 118 moves to block 910.

If the two points i and i+ε 204 are spaced a distance less than the minimum distance threshold or above the maximum distance threshold, the controller 118 moves to block 912.

Block 912 includes the controller 118, given point i of an n^{th} scan, calculating the angle θ_{i,n} of a ray formed between the point i 204 and the point i+ε 204. The angle is defined with respect to the initial orientation 406 of the map, which could be any arbitrary orientation. The value of the angle θ_{i,n} is then added to as a count in a histogram 506.

Block 912 increments the value of i by one, representing the analysis of all point pairs of the given scan n.

Block 914 increments the value of n by one and resets i to zero, representing the analysis of the next scan n+1.

Once all N scans have been analyzed and the histogram 506 is fully populated using data from all N scans, the histogram 506 can be wrapped in block 916. Wrapping of the histogram refers to the truncation of the range of θ from [0, 360) degrees to [0, 90) degrees, wherein values exceeding 90 degrees are reset to zero degrees. In other words, the counts per value of θ per quadrant are overlaid on top of each other. Wrapping of the counts would increase the signal to noise ratio of the peak 606 which defines the primary orientation α of the environment. Wrapping of the histogram also improves the SNR of the peak around α for embodiments wherein N is a limited number of recent scans.

Block 918 includes the controller 118 determining a primary orientation 410 of the map based on detecting a peak in the histogram 506. The peak may be above a requisite threshold T, which may be a static number of counts, a number of counts based on the value of N, or a dynamic SNR threshold. If no value of α can be detected to comprise the requisite SNR, or if multiple values of α are determined (e.g., robot 102 could be in a region surrounded with 45° oriented objects), then the robot 102 may exit method 900 and revert back to using default odometry, such as gyroscopes, until a prominent orientation can be resolved. Temporary use of a drift-prone gyroscope may be permissible for short periods of time wherein drift accumulation is still negligible.

Once the primary orientation value α of the computer readable map is determined, the relative heading angle β(t) of the robot 102 can be quickly calculated using any adjacent surface(s). Upon calculating the heading angle β(t) the controller 118 may compare the value of β(t) to another value for heading angle calculated via integrating the gyroscope. The difference between these two values can be attributed to gyroscopic drift. Since the drift has now been measured, it can be accounted for. This is not necessary for maneuvering the robot 102 with dead reckoning alone, however accounting for drift may be useful for scenarios where the robot 102 navigates beyond any adjacent objects and has to rely on its odometry to localize itself temporarily (e.g., until more surfaces are sensed and dead reckoning can be re-implemented).

There should only exist one peak 506 within the range of [0, 90) if the environment is fully parallelized along only two axes. For instance, the environment depicted in FIG. 4, wherein all surfaces of the objects 402 are either upwards/downwards (with respect to primary orientation 410 directions) or leftward/rightwards. However, some environments may exist with objects 402 oriented at 45° angles with respect to primary orientation 410 directions UDLR. Some environments may contain objects 402 oriented along 30° increments. Accordingly, in some instances, multiple peaks may arise in the histogram if such object orientations exist and are in substantial frequency. In these scenarios, the controller 118 may adjust the wrapping from [0, 90) degrees to instead be [0, 45) or [0, 30) degrees, wherein the primary orientation 410 may contain inter-‘cardinal’ directions. If the objects oriented along 30° or 45° increments are present in small frequencies (e.g., an individual skewed table in an otherwise parallelized dining hall), the counts formed by block 908 along these surfaces may quickly be drowned out by the more prominent orientation values. Preferably, the discretization of the primary orientation 410, although possible, should not be below 30° as errors introduced from sensor noise can become magnified when wrapping and unwrapping (described below) occurs too many times.

Conversely, in some instances, environments may be configured in a triangle-like configuration with the surfaces of the objects therein being in parallel to each other or misaligned by 120° increments. These environments may be detected by determining there are only three spikes in the histogram 502 from [0, 360) degrees, wherein the three spikes do not align when the histogram 502 is wrapped from [0, 90) degrees. The histogram 502 may instead be wrapped every 120°, thereby causing the three spikes to coincide in the wrapped histogram.

According to at least one non-limiting exemplary embodiment, gyroscopic drift may be calculated and negated by utilizing the calculated heading angle of the robot 102 from methods 800 and 900. The controller 118 may calculate the heading angle of the robot 102 via integrating the gyroscope and compare the value to another heading angle calculated via methods 800 and 900. The difference between these two values may correspond to the drift, or accumulated error, of the gyroscopic position which can be subtracted from the gyroscopic position estimation. In other words, the heading angle calculated may be occasionally utilized by the controller 118 to calculate and negate gyroscopic drift by determining the heading angle of the robot 102 using external static objects which are not susceptible to drift.

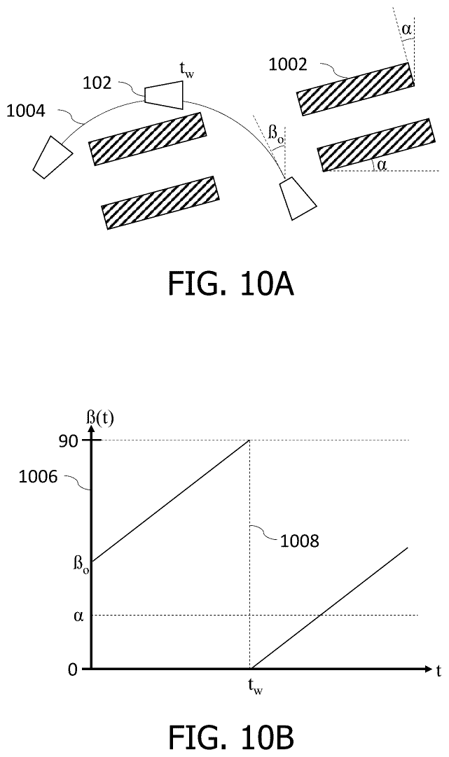

One issue arises in performing this dead reckoning method when the robot 102 turns, specifically when the robot 102 breaches a heading angle equal to 0 or 90 degrees. FIG. 10A depicts a scenario wherein a robot 102 is executing a left-ward turn along a route 1004 nearby various objects 1002, according to an exemplary embodiment. The objects 1002 provide the controller 118, via method 900, with the primary orientation of the map α, from which can be measured continuously and used to define the heading angle of the robot β(t). Advantageously, since the heading angle β(t) is measured with respect to distances to nearby objects which are static, angular drift is substantially eliminated. The arbitrary primary orientation of the map α is defined with respect to the plane of the page in this illustration. At time t=0, the robot 102 is heading at an angle of β(t)ₒ which is somewhere between (90, 180) degrees. After some time, the heading angle β(t) ends somewhere between (180, 270) degrees. The precise value of β(t) over time is not particularly important for the illustrative example, however it is appreciated that it has moved from one ninety-degree quadrant to a different quadrant. Quadrants as used herein are defined with respect to the plane of the page of FIG. 10A, with zero degrees corresponding to the right-ward direction. Since robots 102 cannot teleport, it must be assumed that the two quadrants are adjacent quadrants. As β(t) increases over time as the robot 102 executes the left-hand turn, at some point β(t) will take a value of 90 degrees and, eventually due to the wrapping of θ to be between zero and 90 degrees, jump back to zero degrees as shown. Despite being discontinuous, the graph 1006 shown next in FIG. 10B represents the robot 102 navigating at constant speed and turning at a constant rate.

The graph 1006 depicts the value of the robot 102 heading angle β(t)(t) over time as the robot 102 executes a turn equal to or greater than 90°, wherein the heading angle β(t) is wrapped to be constrained to values of [0, 90) degrees. It can be assumed that the controller 118 has tracked the robot 102 motion and heading angle β(t) sufficiently to determine that β(t)ₒ lies within the second quadrant of [90, 180) degrees with respect to the plane of the page. The graph 1006 contains a discontinuity 1008 which could depict two possible scenarios: (i) the robot 102 heading angle β(t) has moved from quadrant two to quadrant three, or (ii) the robot 102 has moved from quadrant two to quadrant one, wherein quadrant four would require a 180-degree sudden rotation which is never physically possible. It is also appreciated that scenario (ii) is also not physically possible given the momentum of the robot 102 just prior to the wrap around effect at t_{w}. To therefore determine the true heading angle β(t) of the robot 102 at t_{w} across (0, 360) degrees, the controller 118 need consider the angular velocity of the robot 102 just prior to time t_{w}, such as within a preset window of time around or just before t_{w}. Such window may be a few seconds (e.g., 1-2 seconds) or may be longer (e.g., 10-30 seconds, or more) depending on how quickly the robot 102 can turn/move. Upon detecting that β(t) was increasing to 90 degrees and wrapping back to zero degrees, and that β(t)ₒ was somewhere in the second quadrant between [90, 180) degrees, the controller 118 may determine that the robot 102 heading angle has moved to the adjacent quadrant three in the counterclockwise direction. If the graph 1006 was inverse, and β(t) was decreasing (e.g., if the robot 102 moved from left to right in FIG. 10A), the controller 118 would determine that the robot 102 heading angle has moved to the adjacent quadrant in the clockwise direction.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for moving a robot in an environment, comprising:
producing a computer readable map of the environment using data from one or more sensors coupled to the robot, the computer readable map comprising a first orientation of a plurality of objects;
determining a second orientation of the plurality of objects within the environment based on the computer readable map based on a histogram;
calculating a heading angle of the robot based on detecting at least one surface of an object and the second orientation of the objects on the computer readable map; and
determining a displacement of the robot over a period of time based on its speed and heading angle during the period of time.

2. The method of claim 1, further comprising:
populating the histogram by calculating, for every scan used to produce the computer readable map, an angle between two points thereof;
providing the calculated angle to the histogram; and
determining the second orientation based on the largest peak of the histogram which is above a threshold value.

3. The method of claim 2, wherein the histogram is wrapped every 90 degrees for each quadrant of the computer readable map.

4. The method of claim 3, further comprising:
causing the robot to change its heading angle while navigating a route;
determining the heading angle has exceeded 90 degrees or fallen below zero degrees with respect to the histogram;
determining whether the robot has moved into an adjacent quadrant in the counter-clockwise or the clockwise direction based on the heading angle, wherein the robot has moved in the clockwise direction if the heading angle exceeds 90 degrees, and the robot has moved in the clockwise direction if the heading angle is below 0 degrees.

5. The method of claim 2, wherein the two points selected per angle calculation are separated by four degrees or more.

6. The method of claim 1, further comprising:
calculating a second value for the heading angle of the robot using a gyroscope;
determining a difference between the second value and the heading angle of the robot calculated via the histogram; and
adjusting the second value based on the difference.

7. A robot, comprising:
a memory comprising computer readable instructions stored thereon; and
at least one processor configured to execute the computer readable instructions to,
produce a computer readable map of the environment using data from one or more sensors coupled to the robot, the computer readable map comprises a first orientation of a plurality of objects;
determine a second orientation of the plurality of objects within the environment based on the computer readable map based on a histogram;
calculate a heading angle of the robot based on detecting at least one surface of an object and the second orientation of the objects on the computer readable map; and
determine a displacement of the robot over a period of time based on its speed and heading angle during the period of time.

8. The robot of claim 7, wherein the at least one processor is further configured to execute the computer readable instructions to,
populate the histogram by calculating, for every scan used to produce the computer readable map, an angle between two points thereof;
provide the calculated angle to the histogram; and
determine the second orientation based on the largest peak of the histogram which is above a threshold value.

9. The robot of claim 8, wherein the histogram is wrapped every 90 degrees for each quadrant of the computer readable map.

10. The robot of claim 9, wherein the at least one processor is further configured to execute the computer readable instructions to,
cause the robot to change its heading angle while navigating a route;
determine the heading angle has exceeded 90 degrees or fallen below zero degrees with respect to the histogram;
determine whether the robot has moved into an adjacent quadrant in the counter-clockwise or the clockwise direction based on the heading angle, wherein the robot has moved in the clockwise direction if the heading angle exceeds 90 degrees, and the robot has moved in the clockwise direction if the heading angle is below 0 degrees.

11. The robot of claim 8, wherein the two points selected per angle calculation are separated by four degrees or more.

12. The robot of claim 7, wherein the at least one processor is further configured to execute the computer readable instructions to,
calculate a second value for the heading angle of the robot using a gyroscope;
determine a difference between the second value and the heading angle of the robot calculated via the histogram; and
adjust the second value based on the difference.

13. A non-transitory computer readable medium comprising computer readable instructions stored thereon that when executed by at least one processor configure the processor to,
produce a computer readable map of the environment using data from one or more sensors coupled to the robot, the computer readable map comprises a first orientation of a plurality of objects;
determine a second orientation of the plurality of objects within the environment based on the computer readable map based on a histogram;
calculate a heading angle of the robot based on detecting at least one surface of an object and the second orientation of the objects on the computer readable map; and
determine a displacement of the robot over a period of time based on its speed and heading angle during the period of time.

14. The robot of claim 13, wherein the at least one processor is further configured to execute the computer readable instructions to,
populate the histogram by calculating, for every scan used to produce the computer readable map, an angle between two points thereof;
provide the calculated angle to the histogram; and
determine the second orientation based on the largest peak of the histogram which is above a threshold value.

15. The robot of claim 14, wherein the histogram is wrapped every 90 degrees for each quadrant of the computer readable map.

16. The robot of claim 15, wherein the at least one processor is further configured to execute the computer readable instructions to,
cause the robot to change its heading angle while navigating a route;
determine the heading angle has exceeded 90 degrees or fallen below zero degrees with respect to the histogram;
determine whether the robot has moved into an adjacent quadrant in the counter-clockwise or the clockwise direction based on the heading angle, wherein the robot has moved in the clockwise direction if the heading angle exceeds 90 degrees, and the robot has moved in the clockwise direction if the heading angle is below 0 degrees.

17. The robot of claim 15, wherein the two points selected per angle calculation are separated by four degrees or more.

18. The robot of claim 13, wherein the at least one processor is further configured to execute the computer readable instructions to,
calculate a second value for the heading angle of the robot using a gyroscope; determine a difference between the second value and the heading angle of the robot calculated via the histogram; and
adjust the second value based on the difference.
